(19) United States
(12) Patent Application Publication
(10) Pub. No.: US 2010/0148946 A1
(43) Pub. Date: Jun. 17, 2010

(54) Surveillance System

(75) Inventors: Pierre Strombeck, Lidingo (SE); Peter Strombeck, Lidingo (SE); Daniel Sveneson, Johanneshov (SE)

Correspondence Address: POTOMAC PATENT GROUP PLLC, P. O. BOX 270, FREDERICKSBURG, VA, 22404, US

(73) Assignee: Portendo AB, Stockholm (SE)

(21) Appl. No.: 12/335,843

(22) Filed: Dec. 16, 2008

(51) Int. Cl. G08B 21/00; G08B 17/12; B60Q 1/00

(52) U.S. Cl. 340/425.5; 340/540; 340/600

(57) ABSTRACT

Surveillance system for automatic detection and presentation of threat indications, the system comprising several threat indication detectors (1, 2) and at least one central unit (3) adapted for communication with said threat indication detectors (1, 2) and for presentation of threat images. Threat information signals are transferred automatically from the threat indication detectors to the central unit, and each threat indication detector (1) can be located both immobile, semi-mobile of mobile.

### TECHNICAL FIELD

This invention relates to a method and a system for automatic and continuous detection and presentation of threats in real-time, and a threat indication detector adapted to be included in such a system.

### BACKGROUND OF THE INVENTION AND PRIOR ART

Daily, the world around us is threatened by terrorist organizations attempting e.g. to influence the political direction of the world, by means of various bombing attacks against buildings and people. For this reason, most states are provided with authorities for monitoring and fighting security threats, e.g. the customs, intelligence service and the police. Their surveillance methods mainly consist of intelligence activities, in combination with isolated efforts of special forces trained to detect bombs, gas attacks and similar threats to the security. Normally, the bomb searching will be performed by specially trained dogs, while the custom officers and security personnel at airports and in harbors also use scanners for the scanning of luggage and passengers.

During the production of explosives, drugs and Chemical Warfare Agents, elevated amounts of precursors, i.e., agents used in the manufacturing of explosives, are normally present in the air. Evidence of this is found in the reports by residents in the neighborhood around the Leeds “bomb factory” where the explosives for the London bombs of July 2005 were made.

Preventing terrorist attacks while they are already in motion is extremely difficult. Not only is it difficult to find an explosive on a person or in a bag but one also must face the need to do this in a very short time and then immediately implement measures for countering the attack once a possible suspect or suspicious object has been found.

Today, the possibilities to detect and uncover sites of substance production are limited. However, production of drugs and preparation of a terror attack such as the bombings in London takes time. Production of drugs is a more or less continuous effort from the criminals making them. A timeline for the terrorist preparations could be described as follows:
1. Planning and financing, possibly including theft or robbery
2. Obtaining equipment and material
3. Preparation and production
4. Transportation
5. Execution of the attack

Normally, the security surveillance regarding threats is based on intelligence activities, e.g. by the public tipping and informing the police and the customs. This information is analyzed, and if it is relevant, a supplementary inspection and investigation may be performed on site by police officers and customs officers. Security surveillance may also, in some situations, be performed by precautionary scanning of an area. Normally, dogs or some type of equipment, based e.g. on gas chromatography of spectrography, will be used when detection is performed at an inspection. All of these methods are very costly and require well-trained inspection teams for handling the dogs and for using the inspection equipment.

Previously known detection systems within this field have several disadvantages, e.g. they involve high costs, require handling and active participation of trained personnel, are not adapted for continuous surveillance, lack real-time reporting to a common surveillance central for a compiled presentation of threats, and have low area coverage.

There is thus a need for a surveillance system providing a cost efficient and continuous detection and presentation of threat indications in real-time, in order to allow an efficient action by personnel, if needed.

### SUMMARY OF THE INVENTION

A method of detecting and presenting threat indications is provided, the method comprising the steps of providing a plurality of threat indication detectors for a continuous analysis of the environment in order to detect threat indications, providing a central unit, sensing, by means of the threat indication detectors, threat information comprising type of threat, detector position, and point of time, automatically transferring the threat information sensed by the threat indication detectors to the central unit, receiving by the central unit threat information transferred automatically from the threat indication detectors, automatically compiling the threat information by the central unit into compiled threat indications, and graphically presenting the compiled threat indications.

In a preferred embodiment, the method comprises presenting the compiled threat indications as a map, preferably with the dynamics of variations.

In a preferred embodiment, the step of sensing comprises sensing threat indications originating from any of the following: explosives, precursors, and markers.

According to a second aspect, a system for detection and presentation of threat indications is provided, the system comprising a plurality of threat indication detectors, each threat indication detector comprising sensing means adapted for continuous analysis of the environment to determine threat indications and type of threat, positioning means adapted for determining current detector position, time indication means adapted for determining current point of time, and detector communication means adapted for automatic transfer of threat information signals to a central unit, wherein said threat information signals indicate type of threat, detector position and point of time, at least one central unit comprising: central unit communication means adapted to communicate with said detector communication means, compilation means for automatic compilation of received threat information signals into compiled threat indications, and presentation means for geographical presentation of said compiled threat indications.

### BRIEF DESCRIPTION OF THE DRAWINGS

The invention will be described in more detail below, with reference to the FIGS. 1-4, of which:

FIG. 1 schematically illustrates a surveillance system according to the invention,

FIG. 2 schematically illustrates the components in a threat indication detector comprised in this invention,

FIG. 3 schematically illustrates a central unit according the invention, and

FIG. 4 illustrates part of a city wherein a surveillance system according to the invention is used.

### DETAILED DESCRIPTION OF THE INVENTION

A system according to the invention is illustrated in FIG. 1 showing two threat indication detectors 1, 2, which are communicating with a central unit 3. One of the threat indication detectors 1 is provided with positioning equipment 6, such as GPS, and a wireless radio-frequency connection 5 with the central unit, and is in this manner adapted for an immobile as well as for a mobile location. The expression “mobile location” indicates that the threat indication detector is placed on a location that is movable while in operation, which means that it may be mounted e.g. in a vehicle, or portable and carried by a person. The expression “immobile location” indicates that the threat indication detector is located to be stationary while in operation, which means that it may be mounted e.g. in a building. The second threat indication detector 2 in FIG. 1 is arranged exclusively for an immobile location, which means that it has a wire connection 4 with the central unit 3, and no active positioning equipment is needed. The expression “semi-mobile” indicates a movable location, involving a pre-determined movement, such as in a train or an airplane.

The threat indication detectors 1, 2 included in a system according to this invention are adapted to perform continuous detection of threat indications. The threat information relating to the detected threat indication is transferred automatically, either wirelessly via e.g. a wireless radio-frequency connection 5 or by wire 4, to the central unit 3, and the threat information may comprise type of threat, point of time, position, and preferably detector identity. The threat information relating to each threat indication detection is, thereafter, compiled in the central unit 3 into threat indications. The compiled threat indications are then presented graphically, such as an information picture, preferably a continuous geographical threat information picture.

An embodiment of a system according to the invention is a surveillance system comprising one or more central units 3, to each of which an arbitrary number of threat indication detectors 1, 2 are connected, each designed for a mobile location by being provided with positioning means and adapted for wireless radio-frequency connection with a central unit 3. However, a threat indication detector 1 may also be provided with a wire connection 4 for a permanent connection to a central unit, to be used in an immobile location. The surveillance system may further comprise threat indication detectors 2 intended only for an immobile location.

Each central unit 3 receives threat information transferred automatically from the threat indication detectors 1, 2 within the system, and compiles the information automatically into a threat indication picture, which is suitably presented, e.g. on a display screen, as a map provided with superimposed threat indication markers, which may be updated continuously. Thereby, the staff that is present at the central unit gets an opportunity to monitor the displayed threat indication picture, and can easily discover a detected threat indication, determine the type of threat and its position, and in this way quickly determine the extent of a threat and take the necessary steps, such as e.g. to alert personnel to perform an inspection or an action on the location of the threat indication.

A threat indication detector 1, 2 according to this invention has a different design depending on whether it should be capable of mobile location or only immobile location or both mobile and immobile location. It can also be designed differently regarding the mounting means, to be mountable permanently of detachably, e.g. in a building or in a vehicle, and/or to be portable.

The threat indication detector comprises a sensing part for monitoring of the surrounding environment, and the sensor is adapted to convert indications regarding e.g. explosives, gases, organisms and radiation to an electric signal. This threat type indication signal is, thereafter, combined with positioning information from the positioning means comprised in the detector, and with time information and preferably detector identity, into a threat information signal, which, thus, indicates the type of threat, the position, preferably the detector identity and point of time. This threat information signal is automatically transferred to the central unit, by means of the internal communication means of the detector.

Since a threat indication detector according to this invention is designed either to be located both mobile and immobile, or only immobile, to be permanently or detachably mounted, or to be portable, and to function autonomously, with an automatic transfer of detected threat indications to a central unit, a very efficient, flexible and non-predictable scanning of an area regarding threat indications is possible. A mobile location means to e.g. be carried by a person, an animal or in a vehicle, while an immobile location means to be mounted e.g. in a building. The transfer of the threat indication signals is preferably taking place in real-time, i.e. in connection with a detection. A detector can be designed with a sensing part that is consumed during use of the detector, and such a detector is preferably adapted to inform the central unit in case the detector needs maintenance. A threat indication detector according to this invention is designed for a continuous analysis of the environment with respect to the presence of one or more substances, radiation or organisms. When detection has occurred, the information is transferred in a threat information signal sent from the detector to a central unit, relating to the type of threat, point of time, and the position, and preferably also denoting the detector identity. The detector can also be designed to denote the concentration and/or quantity of a detected substance, to be included in the transferred threat indication signal.

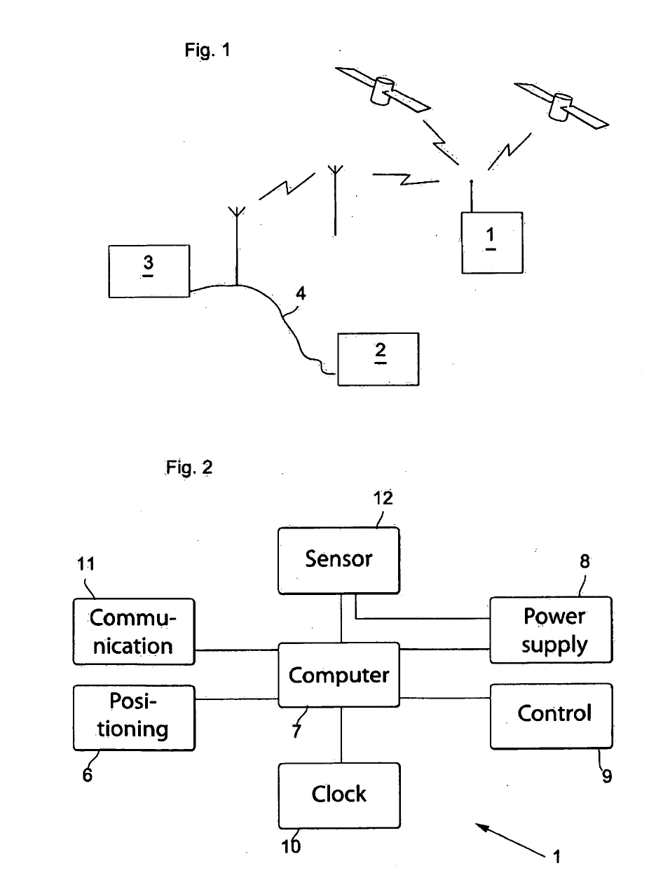

The parts of a threat indication detector 1, according to an embodiment designed for both immobile and mobile location, is illustrated in FIG. 2, comprising a computer 7, power supply 8 with a battery and a voltage converter, control means 9 for supply voltage and program execution, clock 10 for time stamps and time control, communication means 11, having a wireless interface with receiver, sender and an antenna, and possibly also a wire interface, positioning means 6 for localization, comprising a receiver and antenna for satellite reception, and a sensor 12 for one or more substances, organisms or radiation. The parts comprised in the detector, as above, will now be described in more detail below, with reference to FIG. 2.

The sensor 12 included in the detector according to the invention senses the substance, radiation and/or organism, and by reading the sensor signals the detector is informed of the type and quantity. Some types or sensors have a limited durability, and in this case the detector may give notice when the sensor is consumed.

The power supply 8 in the detector may consist of a built-in battery. If suitable, a complementary or alternative external power supply may be provided, e.g. solar cells, a mains supply, or a power supply of a vehicle.

A threat indicator detector 1 adapted for mobile placement performs locating by means of built-in positioning equipment 6 for geographical locating. A preferred embodiment of a detector adapted for mobile placement uses satellite positioning (e.g. GPS (Global Positioning System), Glonass, or Galileo) combined with radio-based locating (e.g. GSM (Global System for Mobile communication), 3G), but radio systems without locating function primarily uses satellite positioning.

A threat indication detector 2, only adapted for immobile locations, may alternatively store data regarding the detector location in the central unit, wherein no active positioning equipment is required.

A threat indication detector 1 adapted for both mobile and immobile locations primarily communicates via a wireless connection, such as by radio communication, but it may, additionally, be provided with an interface for a wire connection to be used in an immobile location. Preferably, the communication is two-way, in order to provide an opportunity for remote control and remote maintenance of the detector.

A clock 10 in the detector performs time stamping and time control of events and the clock is synchronized by means of satellite positioning equipment or a communication link.

The control means 9 in the detector supervises the operating status, reports error conditions, and resets the detector in case of en emergency error.

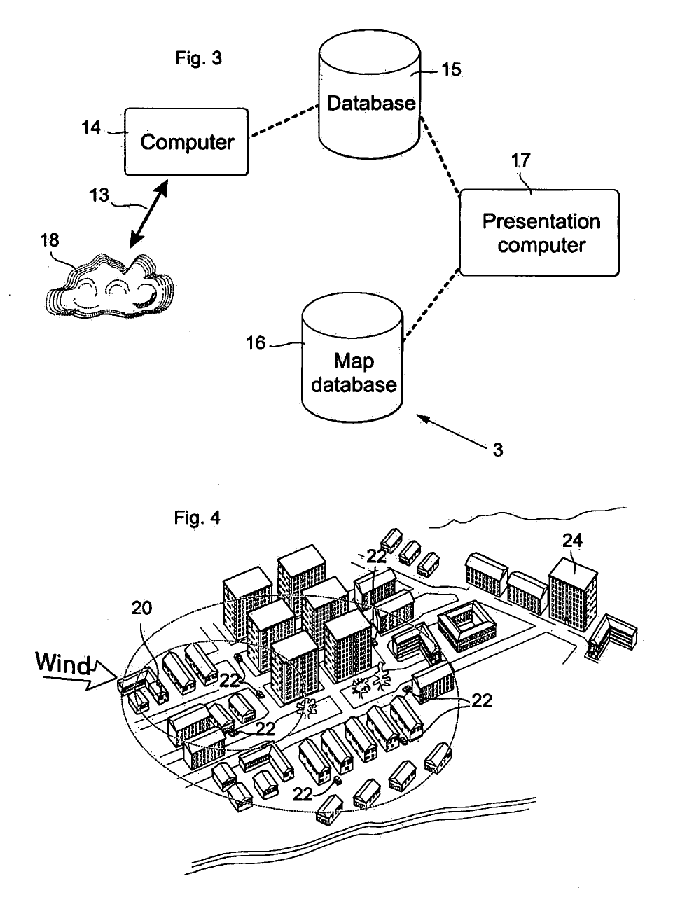

A central unit 3 according to an embodiment of the invention is illustrated in FIG. 3, and comprises a communication link 13 to a network connection 18, e.g. a telecommunication network, the Internet, or radio, a computer 14, a central unit database 15 for storage of threat indication information, a GIS (Geographic Information System) database 16 for map information, and one or more computers 17 for the presentation.

The central unit 3 receives and stores information transferred from the threat indication detectors 1, 2 as threat information signals, and compiles and presents the threat information. The presentation can take place in several ways, such as maps with threats and threat variations, standard levels and deviations, the dynamics of variations, etc. A large number of detectors lead to a continuous, redundant surveillance and high geographical resolution. The central unit communicates with the detectors, and with other central units, as well, if necessary. The detectors transfer information to the central unit, which is able to return information to the detectors regarding control and maintenance. The central unit may also communicate with other centrals/systems, such as other security or surveillance centrals, or with the police or with guards. Processing is performed when threat information signals are received from the detectors, the processing comprising forwarding of the information to the police or to guards and using the information from the detectors to generate a time varying geographical presentation of the detected threat indication. Some of the integral part of a central unit, as above, will be described in more detail below, with reference to FIG. 3.

The communication performed by a central unit involves sending and receiving information to/from the detectors, other central units and liaison centrals. The communication is performed by means of a communication link 13, wirelessly or by a wire connection or via an existing network, e.g. the Internet or a telecommunication network. Presentation of the threats can e.g. be performed by showing a map on the display of a computer 17 for presentation, such as a city map, onto which the information regarding detected threats is superimposed. Various geographical properties or numerical attachments can be used for the type of threat, actuality, movement, level, variations, speed of the variations, etc. The presentation in the central unit can be event controlled by the occurring threats, or show a predetermined surveillance area. Other types of presentations may take place, if necessary, such as airplane and satellite images, diagrams, tables, statistics, time variations, etc.

By using threat indication detectors located in public buildings and places, in public communications and cargo transporting vehicles and carried by police officers and guards, threat information is obtained with high area coverage. Detection takes place e.g. when radiation or molecules from a substance or organism is sensed by a sensor of a detector, which may be caused by the substance being brought or transported in the vicinity of a detector, or by a mobile detector being brought or transported in the vicinity of the substance. When threat indication detection occurs, the detector reports the type of detection and time and place to a central unit as a threat information signal sent from the detector to the central unit. The central unit stores the report with the threat information signals in the central unit database 15, wherein the information can be selected and presented according to the requirements. By means of continuous reading and reporting in real-time, intelligence information regarding a type of threat and its origin is created and regarding changes in and movements of a threat. This information can be presented in several different ways, geographically and statistically.

Since both immobile and mobile location of the detectors is possible, an area-covering (inside buildings also volume-covering) network with scanning points can be created. The immovably located detectors scan threats in the vicinity, which comprises threats passing through the vicinity. One example is immovably located detector mounted on water pipes to sense threats including contamination or additives in the drinking water. Immovably located detectors in buildings, in venting systems, entrances to sports centers, etc. are able to sense threats brought into or placed inside a building. The movably located detectors can e.g. accompany transporting vehicles, such as subway trains, ships, trailers, containers, buses, or cars. Portable detectors are carried or mounted detachably for daily use, and can be carried by uniformed personnel, such as police officers, custom officers, postmen, garbage collectors, etc. or by non-uniformed personnel, such as security officers, employees, volunteers at sports events, private persons, or even by animals. These detectors can also be used for temporary mounting on bicycles, boats, motor vehicles, and at various events and conferences that requires scanning.

The flexible system with threat indication detectors adapted for immobile and/or mobile locations allows an area-covering scanning, being static as well as dynamic. Detectors adapted for mobile location can accompany vehicles, cargo and transporting routes and, thereby, accomplish scanning of locations with an organized transport of people and cargo. A movably located detector may be moved along a predetermined route, e.g. of a postman or a garbage collector, or along completely unpredictable routes of e.g. a police officer, a security officer or any private person. Altogether, this provides a scanning area that is extremely difficult to predict for someone wishing to avoid a detection, and at the same time the scanning is able to cover most places, vehicles and the inside of building.

A great advantage with this invention is that the detectors are designed for autonomous use, but an active participation by personnel is also possible. However, the detectors are normally used autonomously, i.e. the measuring and communication is performed by a detector without participation of anyone. This means that a carrier and those around him or her are unaware of an occurred detection and of a central unit having received information from the detector.

Certain types of detectors require regular replacement of old filters, sensor parts or batteries. These detectors will send a notification to the central unit when a replacement has to be performed, to be forwarded to maintenance personnel. The operating status is checked and possible errors notified to the maintenance staff by means of a regular communication between the central unit and each detector.

The information transfer between the detectors and the central unit is performed automatically, and the information can be processed in one or more central units, depending on the circumstances. According to a possible embodiment of the system according to this invention, a local central unit handles all threats within a defined geographical area, and according to another possible embodiment of the system, a particular central unit handles a particular threat indication type.

By identifying each detector in association with the transfer of threat information to a central unit, threat indications can be evaluated and sorted out if they are generated erroneously. Detectors that may be in the wrong hands can be shut off from further operation by means of remote control from the central unit.

Monitoring of the presentation in the central unit 3 may be performed by manual reading of the presentation computers 17 or via automatic alerts from a database server, which may be portable, or by means of a suitable combination of these methods. A portable computer allows an interactive field use. The display on the presentation computer 17 can be based on presentation integrated with graphics, such as maps, pictures, e.g. air photos, as diagrams (statistics), as a text, as a movable graphic/picture or as a combination of any of these. Information from the presentation computer 17 can be forwarded, either completely of partly, to field personnel or to other central units.

The information stored in the database 15 regarding a threat indication can either be selected or complete. Examples of information to be stored are the type of threat, type of detector, detector identity, position coordinates, movements and propagation pattern, and information regarding a threat indication position, such as a map, a picture, information regarding a location, a particular building, a road, a particular vehicle, or the names of certain people.

The above-described system allows an efficient, flexible, autonomous and non-predictable scanning of an area regarding threat indications. An example of such scanning of a city area will now be described with reference to FIG. 4. In the described embodiment, the scanning is primarily used for detection of illicit production of explosives and drugs during the production stage. This embodiment is based on mobile sensors mounted in law enforcement and/or other vehicles under community control. Findings from the sensors, such as type and amount of substance, position and time, are sent, independent of the operator, to a central unit (not shown in FIG. 4, where data is collected and evaluated for further action.

In FIG. 4, reference numeral 20 indicates a clandestine production center of illicit substances, such as explosives, toxic agents or drugs. With many such substances, significant levels of identifiable molecules are spread in the surrounding atmosphere. Areas with different levels of these molecules are indicated by ellipses in the figure. The shape and size of these areas affected for example by the direction and strength of the wind, indicated by an arrow in the figure.

Reference numerals 22 indicate sensor-equipped vehicles, i.e., mobile threat indicator detectors. These vehicles can be any kind of vehicle equipped with a sensor, but the vehicles are typically police cars, postal vans, fire brigade trucks etc. The sensor is preferably a hidden, independent system that automatically reports its findings. No interaction from the driver is necessary. The general principles of the sensors have been described above with reference to FIGS. 1-3.

A surveillance central 24 is also shown in the figure. This surveillance central comprises a central unit, as described above.

In order to filter out false high readings due to a normal high amount of precursors in the air in a particular area, the normal amounts of precursors for the different areas of interest are preferably mapped. When the “background” levels for the areas have been determined, the filtering of high readings based on time of day, weather and other external factors that are identified to have influence on the amount of precursors in the air will be fine tuned.

Instead of sensing precursors, sensing of so-called markers, i.e., substanses added to explosives to ease identification thereof, can be used.

In the present invention, using the dynamics of variations improves the accuracy of the detection. This is reflected by the following example. Hair dressers use bleaching agents similar or identical to agents used for manufacturing of explosives. Thus, the presence of such agents in the vicinity of a hair dresser's saloon during work days would not indicate a threat. However, if such agents are present during weekends, when the hair dresser's saloon is closed, this presence would indicate a threat, namely that someone is using an agent for making bombs. Another example is plants manufacturing or using similar chemical agents, and which are closed on weekends. Thus, by taking into consideration the standard level variations and dynamics of variations, improved detection of threats is achieved.

When a high reading has been detected and identified, there are two outcomes:
1. The high reading is due to the production of one of the substances of interest—a positive reading.
2. The high reading is due to a presumably abnormal high concentration of precursors.

In the first case the identification is reported and then handled according to established procedures. The second case can result in that either the background level has increased due to natural or legal activities or this is a temporary high reading. In either case there might be need to update the model for the “background” levels.

The concentration of precursors and other substances which is reached at a certain distance downwind outside a building is dependent upon many parameters such as:
The physical properties of the chemical
The chemical properties of the chemical
The characteristics of the building, such as size and ventilation
The local weather and background concentrations

By choosing a limited number of chemicals, such as solvents, that represent a range of illegal products and by determining their properties, defining some characteristic “laboratory buildings” and choosing a number of local weather situations, detection of threat indications can be facilitated. These assumptions lead to a number of combinations, scenarios, of which for every scenario one can estimate the concentration of “chemical X” at distance Y from the building.

There are in general three ways to estimate the concentration:
By a, possibly simplified, dispersion model
By Computational Fluid Dynamics (CFD) simulations
By measurements in a real environment

The most commonly employed instruments for trace detection of explosives, which typically are deployed at airports, are based on Ion Mobility Spectrometry (IMS) technology. IMS is quite sensitive, easy to use, field deployable and available at reasonable cost.

The preferred networking technology is standard GSM and GPRS based networking. An example of networked information system to manage the explosive detection reported in an airport by software developed by SecureLogic Corp, Netanya, Israel, which performs command and control of explosives detection system machines at multiple check-points or in line for bag screening operation. The software can monitor several explosives detection system machines at various checkpoints, the number of screening personnel on duty, the number of passengers in each line and the number anticipated.

An important part of networking is the creation of a secure system. Self-organization is preferred for initial trust setup with protocols that will allow the sensor network to operate in a dynamic communication environment where nodes may leave or join the network on-the-fly.

The inventive apparatus and method focus on the preparation and production phase of the terrorist plot, providing intelligence of a sort that is otherwise normally not available. This intelligence covers a gap where little information is available from other sources. Detection in this phase has several advantages compared to detection of the explosives themselves for example during the transportation phase. In the production phase there are:
More vapor to detect
Sufficient time for further investigation
Sufficient time to respond appropriately
Time to protect innocents during the intervention

The sensors used by the invention are preferably based on physical detection methods that are adaptable to new substances. The wireless network enables the sensors to be remotely updated for new substances making the concept adaptable to changing and/or new threats.

Online detectors necessary for the detection of precursor chemicals are chosen based on their properties. Preferred detectors are IMS detectors, differential Mobility Spectrometry (DMS) detectors, and Surfaced Enhanced Raman Scattering (SERS) detectors.

IMS detectors are state-of-the-art for detection of explosives and Chemical Warfare Agents. IMS technology is based on the separation of ions by their mobility in a carrier gas as measured by drift time. Currently, IMS based detection devices are designed as detect-to-warn (rather than detect-to-identify) devices with integrated data evaluation which presents the detection results to the user by audible and visible alarm. According to the invention, the IMS sensor will record spectral data which will be processed in the information evaluation process. This is a novel application since there is no need for feed-back to the detection platform. The data evaluation can be performed subsequently, and be supervised by specialists.

The detect-to-warn approach requires that the precursor is a part of the built-in detection library. This is used to avoid false alarms from interferents. In the preferred method, the monitoring of all chemicals with a higher proton affinity than water provides access to a wide range chemical monitoring capability.

DMS is a technology closely related to IMS that is in the state of the art in field detection of explosives and chemical warfare agents. Both technologies are based on the measurement of electrical mobility of ions but with an important difference: in an IMS, the separation of ions is made in time while in a DMS, separation of ions is made in space. This difference leads to a superior theoretical performance of DMS mainly for the possibility of making continuous measurements (that will be reflected in higher sensitivity) and the possibility to perform parallel detection by means of a multitrack detector (that will affect response time).

The DMS principle of operation is based on the space separation of ions due to perpendicular fluid dynamic and electric fields in a cavity. Ions entering a slit are subjected to two perpendicular forces: flow and electric field forces.

Depending on their electrical mobility ions will follow different trajectories. Usually an exit slit is placed downwards the inlet. Only ions with a narrow range of mobilities pass through the slit to the sensor where they are detected. Usually a scanning of the applied voltage to the electrodes is performed to obtain a complete mobility spectrum.

In the inventive apparatus the exit slit will be replaced with a multitrack sensor so that the scanning is no longer required.

Surfaced Enhanced Raman Scattering (SERS) for explosives and precursor detection is also in early stages of research and development. Very good results have been achieved on a number of explosives, including peroxide based explosives such as TATP, in laboratory tests.

Raman Spectroscopy is a well-known technique for substance identification used in many laboratories. Due to its relatively insensitive nature it has found few applications for sensor use even though its uncomplicated use should be advantageous. The advent of SERS, a technique where interactions between the detected substance an a surface upon which it is deposited increase sensitivity by orders of magnitude, has made this technology one of the most sensitive.

A patent-pending surface technology uses a self-assembling nano-structured membrane with millions of nano-particles. This technology is described in the U.S. patent applications Nos. 60/697358 and 60/697359, which is incorporated herein by reference. Being self-assembled, the volume production costs of the membrane are very competitive. The membrane structure also enables vapor to flow through the membrane, thereby simplifying trace detection of vapor. Lab measurements on several types of explosives, including improvised explosives, have shown excellent sensitivity. The small size of the membrane, as well of the other sensor components, promises very good possibilities for miniaturization down to the size of mobile phones.

To complement the sensors, a vapor pre-concentrator is preferably used. It will be based on thermal adsorption-desorption on a chemical trap. Most suitable materials, such as polymers and activated charcoals, can be used for the trap.

Continuous time operation will produce a huge amount of data that needs local elaboration and processing before being transmitted over the sensor network. However, this continuous time operation permits the use of advanced multivariate signal processing and chemometrics tools that may provide additional robustness to state of the art instruments. Moreover, due to the increasing computing power available in Digital Signal Processing (DSP) and embedded systems, advanced algorithms are preferably run in real time. Multivariate signal processing may be used to increase system selectivity beyond that offered by the instrument. Signal processing is preferably be used also to compensate for temperature and pressure variations. Finally, time continuous operation is preferably used to implement adaptive filters for improved event detection and for the identification of unexpected sources of variation and correction of environmental drifts.

When an event is reported, the detector device will be reporting through the sensor network what and how much was detected, when and where it was detected and a degree of confidence.

Although networking the sensors should be a standard task, the management of the sensor information, background subtraction and back tracing of the source is quite challenging. The system also needs to report the data to users in a manner that enables an efficient response to potential threats.

The invention addresses the presentation of detected threats for early warning and reporting to a user in a command or monitoring centre. Such a presentation has a great influence on the decisions and actions taken by the end user. This presentation supports a dynamic decision-making. A common model is the OODA (Observe-Orient-Decide-Act) loop. The command centre display unit will increase the situation awareness consisting of different visualized representations to show:
An alarm location on a map.
Alarm type (identified substance and amount), time, location, and the degree of confidence in the identification.
Threat nature as synthesized by data fusion of multiple sensor data.

By applying the proposed model (see page 8) for precursor background levels, the quality of the information is increased and the user will ideally only have to act on true positive readings.

The present invention is not limited to the embodiments described above, but may be modified within the scope of the appended claims.

1. A method of detecting and presenting threat indications, the method comprising the following steps:
providing a plurality of threat indication detectors for a continuous analysis of the environment in order to detect threat indications,
providing a central unit,
sensing, by means of the threat indication detectors, threat information comprising type of threat, detector position, and point of time,
automatically transferring the threat information sensed by the threat indication detectors to the central unit,
receiving by the central unit threat information transferred automatically from the threat indication detectors,
automatically compiling the threat information by the central unit into compiled threat indications, and
graphically presenting the compiled threat indications.

2. The method according to claim 1, wherein the step of graphically presenting the compiled threat indications comprises presenting the compiled threat indications as a map.

3. The method according to claim 2, wherein the step of presenting the compiled threat indications comprises presenting the compiled threat indications as a map with the dynamics of variations.

4. The method according to claim 1, wherein the step of presenting the compiled threat indications comprises providing a presentation integrated with graphics, pictures, diagrams, text, a movable graphic, a movable picture or a combination of any of these.

5. The method according to claim 1, wherein the step of sensing by means of the threat indication detectors is performed during movement of the threat indication detectors.

6. The method according to claim 1, wherein the step of sensing comprises sensing threat indications originating from any of the following: explosives, precursors, and markers.

7. The method according to claim 1, wherein the step of sensing comprises sensing threat indications originating from hazardous gases, radioactive material or organisms.

8. The method according to claim 1, wherein the step of sensing is performed autonomously.

9. The method according to claim 1, wherein the step of presenting the compiled threat indications comprises presenting the compiled threat indications as a map with threats and threat variations.

10. The method according to claim 1, wherein the step of presenting the compiled threat indications comprises presenting the compiled threat indications as a map with standard levels and variations.

11. The method according to claims 1, wherein the threat information comprises detector identity.

12. The method according to claim 1., wherein the threat indication detectors are movable.

13. The method according to claim 1, wherein the threat information comprises type of detector, detector identity, position coordinates, or movements and propagation pattern.

14. The method according to claim 1, wherein the threat information comprises information regarding a threat indication position, comprising a particular building, a road, or a particular vehicle.

15. The method according to claim 1, comprising the step of mapping normal amounts of precursors for different areas of interest.

16. The method according to claim 1, comprising the step of updating a model for background levels.

17. The method according to claim 1, wherein the step of sensing comprises using Ion Mobility Spectrometry technology.

18. The method according to claim 1, wherein the step of sensing comprises using Differential Mobility Spectrometry technology.

19. The method according to claim 1, wherein the step of sensing comprises using Raman Spectroscopy technology.

20. The method according to claim 1, wherein the step of sensing comprises using a vapor preconcentrator.

21. The method according to claim 1, wherein the step of sensing comprises multivariate signal processing.

22. A system for detection and presentation of threat indications, the system comprising:
a plurality of threat indication detectors, each threat indication detector comprising:
sensing means adapted for continuous analysis of the environment to determine threat indications and type of threat,
positioning means adapted for determining current detector position,
time indication means adapted for determining current point of time, and
detector communication means adapted for automatic transfer of threat information signals to a central unit, wherein said threat information signals indicate type of threat, detector position and point of time,
at least one central unit comprising:
central unit communication means adapted to communicate with said detector communication means,
compilation means for automatic compilation of received threat information signals into compiled threat indications, and
presentation means for geographical presentation of said compiled threat indications.

23. The system according to claim 22, wherein the presentation means comprises means for presenting the compiled threat indications as a map.

24. The system according to claim 23, wherein the presentation means comprises means for presenting the compiled threat indications as a map with the dynamics of variations.

25. The system according to claim 23, wherein the presentation means comprises means for presenting the compiled threat indications integrated with graphics, pictures, diagrams, text, a movable graphic, a movable picture or a combination of any of these.

26. The system according to claim 22, wherein at least some of the threat indication detectors are movable.

27. The system according to claim 22, wherein the threat indication detectors are adapted to sense threat indications originating from any of the following: explosives, precursors, and markers.

28. The system according to claim 22, wherein the threat indication detectors are adapted to sense threat indications originating from hazardous gases, radioactive material or organisms.

29. The system according to claim 22, wherein the threat indication detectors are adapted for autonomous operation.

30. The system according to claim 22, wherein the presentation means are adapted to present the compiled threat indications as a map with threats and threat variations.

31. The system according to claim 22, wherein the presentation means are adapted to present the compiled threat indications as a map with standard levels and variations.

32. The system according to claims 23, wherein the threat information comprises detector identity.

33. The system according to claim 22, wherein the threat indication detectors are movable.

34. The system according to claim 22, wherein the threat information comprises type of detector, detector identity, position coordinates, or movements and propagation pattern.

35. The system according to claim 22, wherein the threat information comprises information regarding a threat indication position, comprising a particular building, a road, a particular vehicle, or the names of certain people.

36. The system according to claim 22, comprising the step of mapping normal amounts of precursors for different areas of interest.

37. The system according to claim 22, comprising means for updating a model for background levels.

38. The system according to claim 22, wherein the sensing means is adapted for using Ion Mobility Spectrometry technology.

39. The system according to claim 22, wherein the sensing means is adapted for using Differential Mobility Spectrometry technology.

40. The system according to claim 22, wherein the the sensing means is adapted for using Raman Spectroscopy technology.

41. The system according to claim 22, wherein the the sensing means comprises a vapor preconcentrator.

42. The system according to claim 22, wherein the sensing means comprises a multivariate signal processor.

43. The system according to claim 22, wherein the threat indication detectors are adapted for mobile locations.

44. The system according to claim 22, wherein the threat indication detectors are adapted for immobile locations.

45. The system according to claim 22, wherein the communication means is arranged to establish a wireless connection with the central unit.

46. The system according to claim 44, wherein the communication means is arranged to establish a wire connection with the central unit.

47. The system according to claim 46, wherein said wire connection is adapted for two-way communication.

48. The system according to claim 22, further comprising one or more threat indication detectors adapted exclusively for immobile locations.

49. The system according to claim 22, comprising at least one threat indication detector arranged to be portable.

50. A system according to claim 22, comprising at least one threat indication detector arranged to be mounted on a vehicle.

51. The system according to claim 22, wherein the central unit comprises a database for storing threat information.

52. The system according to claim 22, wherein the movable threat indication detectors are adapted for autonomous sensing during movement of the movable threat indication detectors.
